(19) United States
(12) Patent Application Publication
(10) Pub. No.: US 2004/0261666 A1
(43) Pub. Date: Dec. 30, 2004

(54) Admixture to improve consolidation of cement composition with low moisture content

(76) Inventors: Semyon A. Shimanovich, Brooklyn, NY (US); Christian Meyer, Demarest, NJ (US)

Correspondence Address: Baker Botts, 30 Rockefeller plaza, New York, NY, 10112, US

(21) Appl. No.: 10/466,613

(22) PCT Filed: Sep. 7, 2001
(86) PCT No.: PCT/US01/28024

Related U.S. Application Data
(60) Provisional application No. 60/272,380, filed on Mar. 1, 2001.

(51) Int. Cl. C04B 7/00; C04B 16/00; C04B 24/00

(52) U.S. Cl. 106/809; 106/725; 106/795; 106/811

(57) ABSTRACT

A low moisture composition for producing concrete articles exhibiting increased density and strength and requiring a short consolidation time is obtained by adding a powder admixture of naphthalene formaldehyde condensates to a cement composition.

This invention relates to a method and composition for producing concrete articles in a very short time frame which have increased density and strength. By adding a powder admixture of naphthalene formaldehyde condensates to a cement composition, the time of vibration required for consolidation of such concrete articles is reduced, yet density and strength is increased.

### BACKGROUND OF THE INVENTION

Concrete articles are typically prepared by pouring a cementitious composition into a mould and agitating and pressing it. Generally, the cementitious composition must cure for 18 to 24 hours in the mould before it can be removed as a formed usable concrete article.

Conventionally, water has been added to the cementitious composition to disperse particles of cementitious material and improve the workability of the composition. Unfortunately, the amount of mixing water required for workability is normally a great deal more than necessary for subsequent hydration and setting of the cementitious composition. Hollow spaces formed by evaporation of excess water result in decreased strength of the concrete article of the finished product and instability of the product upon demoulding.

Additives including polycondensation products based on naphthalene sulfonic acids have been used in cement compositions to improve workability and flowability with reduced water-cement ratio as low as 0.23%, but the essential water content comprising at least 10% of material solids by weight moisture. As observed in U.S. Pat. No. 5,798,425, the liquefying action of these additives in cement compositions is short lived and can result in a decrease in workability or slump loss.

Accordingly, there is need for a method of making concrete articles from cement compositions having low water content in a short time period.

### SUMMARY OF THE INVENTION

It is an object of the invention to provide cement compositions having a low moisture content (slump around zero) which are suitable for making concrete articles in a short period of time.

It is a further object of the invention to provide cement compositions having a low moisture content (slump around zero) which can be used to prepare concrete articles exhibiting adequate mechanical strength and stability during manufacture and transport to point of use.

These and other objects of the invention are achieved by providing a cement composition comprising hydraulic cement and 0.5 to 3% by weight of the hydraulic cement of a naphthalene sulfonate condensate wherein the maximum moisture content of the composition is 8% by weight. The invention also provides a method of making a concrete article by introducing the cement composition into a mould, applying pressure and vibration to the cement composition thereby forming a concrete article and removing the concrete article from the mould after the short time.

### DETAILED DESCRIPTION OF THE PREFERRED EMBODIMENTS

The cement composition of the present invention is used to prepare concrete articles which have a moisture content of 8% by weight or less, approximately zero slump, i.e. which do not exhibit any substantial flow. The cement composition can be used in a dry technology process in which simultaneous vibration and high pressure is employed to consolidate the material in a mould. Concrete articles made in accordance with the invention include but are not limited to concrete paving stones, wall blocks, tiles and the like.

The essential component of the inventive cement composition is a powder admixture of naphthalene sulfonate formaldehyde condensates (NSFC) which is mixed with hydraulic cement in the amount of 0.5 to 3% by weight, preferably 0.5 to 1.75% by weight of the hydraulic cement. Suitable NSFC materials include Hydropalat® D available from Cognis Coatings & Inks located in Ambler, Pa. and Lomar D available from GEO Specialty Chemicals in Harsham, Pa.

Any suitable hydraulic cement can be utilized in the cement compositions of the invention. Suitable cements include Portland cement, alumina cement or blended cement, for example, pozzolanic cement, slag cement or other types. A preferred cement is Portland cement of one or more of the various types identified as ASTM Type I to V. The hydraulic cement is present in an amount of 6 to 15% by weight of the cement composition. The cement composition according to the present invention may further contain one or more additives such as fillers, for example, glass powder, quartz, silica and the like, color pigments and reinforcing fibers made of metallic, synthetic or mineral material. These additives are present in up to 40% by weight of the cement composition.

The invention will be better understood with reference to the following illustrative examples which do not limit the scope thereof.

### EXAMPLE 1

| Ingredient | Weight |
|---|---|
| Glass Aggregate | 527.5 |
| Grey Portland Cement Type I | 80.0 |
| Metamax | 20.0 |
| Recycled Glass Powder Filler | 20.0 |
| Water | 41.0 |
| Lomar D | 1.4 |
| Nylon Fibers | 3.76 |
| Pigment | 2.4 |

The ingredients were mixed together in a mixer drum and placed into a block machine manufactured by Zenith Corporation of Germany. Other suitable equipment is available from Columbia Machine, Inc. and Besser Company. Metamax is an Metakaolin admixture available from Engelhard Corporation in Iselin, N.J. The glass powder filler is available from the Glass Recycling Group. A microtrac particle size analysis of the recycled glass powder filler is shown in Table 1.

TABLE 1

| | Size (μm) | | | | | | | | | | | | | |
|---|---|---|---|---|---|---|---|---|---|---|---|---|---|---|
| | 0.9 | 1.4 | 1.9 | 2.8 | 3.9 | 5.5 | 7.8 | 11 | 22 | 31 | 44 | 62 | 88 | 125 |
| Percent Retained | 3.5 | 2.4 | 3.3 | 3.7 | 3.7 | 4.3 | 5.8 | 6.3 | 11.7 | 15.5 | 13 | 13 | 6.8 | 0 |

The glass aggregate was obtained from a glass recycling company who also cleaned the glass. The grading of the recycled glass is shown in Table 2.

TABLE 2

| | Size (μm) | | | | | | |
|---|---|---|---|---|---|---|---|
| | #4 | #8 | #16 | #30 | #50 | #100 | Pan |
| Percent Retained | 0 | 27.6 | 28.3 | 21.1 | 12.1 | 6.7 | 4.2 |

Formed concrete blocks were produced at a rate of 1260 blocks per minute. Concrete blocks were prepared as in Example 1 using the cement compositions shown in Table 6 (batches 12 and 13).

The influence of the powder admixture on compressive strength was investigated for various mixtures. The test result are shown in Table 3. Samples consisted of cylinders 2.8 in diameter and 2.0 in height, which were produced in the laboratory under conditions simulating those in commercial manufacture.

TABLE 3

| | Ingredients, in parts by weight | | | | | | |
|---|---|---|---|---|---|---|---|
| | | | Glass | | | | |
| Sample | Cementitious Mat. | | Powder | Glass | Powder | Moisture | Compressive |
| No. | Cement | Metamax | Filler | Aggregate | Admixt. | Content, % | Strength, psi |
| 2 | 0.8 | 0.2 | 0.24 | 5.275 | 0.0 | 7.6 | 2433 |
| 3 | 0.8 | 0.2 | 0.24 | 5.275 | 0.8 | 6.5 | 2127 |
| 4 | 0.8 | 0.2 | 0.24 | 5.275 | 1.0 | 6.9 | 3047 |
| 5 | 0.8 | 0.2 | 0.24 | 5.275 | 1.2 | 6.5 | 4056 |
| 6 | 0.8 | 0.2 | 0.24 | 5.275 | 1.4 | 6.4 | 3909 |

The compressive strength of the concrete blocks was determined after 7 days using ASTM C67-99a (Volume 04-05). Sample 2 had no NSFC powder admixture. Sample 5 exhibited the highest compressive strength.

### EXAMPLE 2

Concrete specimens were prepared from cement compositions as in Sample 5 using plasticizer additives other than NSFC. These comparative samples are labeled 5A-50 in Table 4 herein below. The compressive strength was measured after 7 days using 2 inch high cylinders with a diameter of 2.8 inches.

TABLE 4

| Sample | Admixtures, % by weight of cementitious mat. | | | | | Moisture | Compressive |
|---|---|---|---|---|---|---|---|
| No. | NSFC | ADVA | Melment | POZ400N | Reo1000 | Content, % | Strength, psi |
| 5 | 1.2 | | | | | 6.5 | 4056 |
| 5A | | 0.8 | | | | 6.6 | 3342 |
| 5B | | 1.0 | | | | 6.6 | 0* |
| 5C | | 1.0 | | | | 6.3 | 4162** |
| 5D | | 0.7 | | | | 6.6 | 3643 |
| 5E | | | 0.8 | | | 7.6 | 2322 |
| 5F | | | 1.0 | | | 6.8 | 2051 |
| 5G | | | 1.2 | | | 6.5 | 1977 |
| 5H | | | 1.4 | | | 6.5 | 1968 |
| 5I | | | | 0.8 | | 6.6 | 1638 |
| 5J | | | | 1.0 | | 6.6 | 2027 |
| 5K | | | | 1.2 | | 6.5 | 2296 |
| 5L | | | | | 1.3 | 6.6 | 2049 |
| 5M | | | | | 1.7 | 6.5 | 2717 |
| 5N | | | | | 2.0 | 6.2 | 2970 |
| 5O | | | | | 2.6 | 6.2 | 3244 |

*Sample could not be demoulded
**Sample was sticky and difficult to demould

ADVA is a plasticizer available from Grace Construction Products. POZ 400N, refers to “Pozolith 400N”, a plasticizer available from Master Builders. Reo 1000 refers to for “Reobuild 1000,” a plasticizer available from the same company. As can be seen from Table 4, Comparative Sample SC was sticky and difficult to demould while Sample 5 in accordance with invention resulted in a concrete block which was easily manufactured and had a high compressive strength.

### EXAMPLE 3

Concrete specimens were prepared from cement compositions in accordance with the invention as in Example 1 and are shown in Table 5 as Samples 7-9. Concrete specimens were also prepared using Reomix 700, an admixture from Master Builders Co., to improve the consolidation property.

TABLE 5

| | Admixtures, | | | |
|---|---|---|---|---|
| Sample | % by wt. of cement. mat. | | Moisture | Compressive |
| No. | NSFC | Reomix700 | Content, % | Strength, psi |
| A | | 0.26 | 6.7 | 2063 |
| B | | 0.5 | 6.5 | 2149 |
| C | | 1.0 | 6.5 | 2129 |
| 7 | 0.8 | | 6.5 | 2127 |
| 8 | 1.0 | | 6.9 | 3047 |
| 9 | 1.2 | | 6.5 | 4056 |

As can be seen from Table 5, Sample 7, 8 and 9 in accordance with the invention gave comparatively superior results with respect to compressive strength.

### EXAMPLE 4

Concrete paving stones were made in accordance with Example 1 from cement compositions as shown in Table 6 using a Zenith block machine. The compressive strength was measured after 28 days.

TABLE 6

| | | | | | | | | | | Compr. | |
|---|---|---|---|---|---|---|---|---|---|---|---|
| | | | | | | | | (Color*) | | Strength, | |
| Batch | Ingredients (% of cementitious materials) | | | | | | | Cure | Moisture, | psi (28 | |
| # | Cement | Metamax | Aggregate | Filter | Pigment | Fiber % | NSFC | Adm. | % | days) | |
| D** | 1 | None | 528 | none | 3 | None | none | 0.725 | <8.0 | 9079 | High vib. |
| E | 0.8 | 0.2 | 528 | none | Yellow-3 | 0.2 Nylon | none | 0.66 | 6.9 | 6820 | High vib. |
| F | 0.8 | 0.2 | 528 | none | Green-3 | 0.2 Nylon | none | 0.66 | 6.8 | 5799 | Low vib. |
| 11 | 0.8 | 0.2 | 528 | rec. gl.-20 | Red-3 | 0.25 Nylon | 1 | 0.66 | 6.6 | 9877 | Low vib. |
| 12 | 0.8 | 0.2 | 528 | rec. gl.-20 | Black-1.9 | 0.2 Nylon | 1.75 | 0.66 | 6.3 | 8184 | Low vib. |
| 13 | 0.8 | 0.2 | 528 | Sphere-20 | Blend-3 | 0.2 Nylon | 1.5 | 0.66 | 6.4 | 11790 | Low vib. |
| *Admixture available from Grinnell Pavingstones, Sparta, N. J. where “rec. gl.” indicates recycled glass, “sphere” indicates glass spheres of particle size 95-100% passing through a 300 um sieve. | | | | | | | | | | | |
| # The blocks of Batches #F, 11, 12, 13 were produced by a high production block machine, but with low vibration level (a vibration duration of only 2-4 s). The blocks of batches #D and E were produced by a lower-level production machine, i.e. a longer vibration duration (4-7 sec.) | | | | | | | | | | | |

**Batch D contains regular sand-like aggregate; all other batches have recycled glass as aggregate.

As can be seen from Table 6 concrete paving stone prepared in accordance with the invention, samples 11, 12 and 13, exhibited high compression strength.

### EXAMPLE 5

A comparison of a paving stone commercially available and a paving stone prepared from an admixture having NSFC in accordance with the invention is shown in Table 7.

TABLE 7
Influence of NSFC Powder Admixture on Regular Concrete. Use for Paving Stone

| | Ingredients (weight part of cement) | | | | | Color** | | | Compr. | |
|---|---|---|---|---|---|---|---|---|---|---|
| | | Mason | Concrete | Stone ¼ | | Cure | | | Strength pi | Consolidation |
| Sample | Cement | Sand | Sand | in. | Pigment | Admixture | NSFC | Moisture % | (7 days) | property |
| G* | 1 | 1.1 | 3.13 | 1.05 | 0.03 | 0.07 | none | 7.29 | 4200 | poor |
| 14* | 1 | 1.1 | 3.13 | 1.05 | 0.03 | 0.07 | 0.012 | 6.5 | 6098 | good |

*Sample made in Carleton laboratory of Columbia University.
**Proprietary admixture used by Grinnell Concrete Paving Stone Co. for pigment distribution.

As can be seen from Table 7, the consolidation property and compression strength for the paving stone prepared in accordance with the invention was superior to commercially available paving stone.

1. A cement composition comprising
hydraulic cement, and
0.5 to 3% by weight of the hydraulic cement of a naphthalene sulfonate formaldehyde condensate wherein the maximum moisture content of the composition is 8% by weight of the composition.

2. A cement composition according to claim 1 wherein the naphthalene sulfonate formaldehyde condensate is present in an amount of 0.5 to 1.75% by weight of the hydraulic cement.

3. A cement composition according to claim 1 wherein the hydraulic cement comprises at least one selected from the group consisting of lime and kaolin.

4. A cement composition according to any one of claim 1 or claim 2 further comprising at least one selected from the group consisting of glass powder, quartz and silica.

5. A cement composition according to any one claim 1 or claim 2 further comprising color pigments.

6. A cement composition according to claim 3 further comprising color pigments.

7. A cement composition according to claim 4 further comprising color pigments.

8. A cement composition according to any one of claim 1 or claim 2 further comprising at least one fiber selected from the group consisting of metallic material, synthetic material and mineral material.

9. A cement composition according to claim 3 further comprising fiber selected from at least one selected from the group consisting of metallic material, synthetic material and mineral material.

10. A cement composition according to claim 4 further comprising fiber selected from at least one selected from the group consisting of metallic material, synthetic material and mineral material.

11. A cement composition according to claim 5 further comprising fiber selected from at least one selected from the group consisting of metallic material, synthetic material and mineral material.

12. A cement composition according to claim 6 further comprising fiber selected from at least one selected from the group consisting of metallic material, synthetic material and mineral material.

13. A cement composition according to claim 7 further comprising fiber selected from at least one selected from the group consisting of metallic material, synthetic material and mineral material.

14. A method of preparing a concrete article comprising
providing a cement composition according to any of claim 1 or claim 2, and
applying at least one selected from the group consisting of pressure and vibration to cement composition thereby forming a concrete article.

15. A method according to claim 14 comprising applying at least one selected from the group consisting of pressure and vibration for 2 to 6 minutes thereby forming a concrete article.
